(19) United States
(12) Patent Application Publication
(10) Pub. No.: US 2017/0025769 A1
(43) Pub. Date: Jan. 26, 2017

(54) TERMINAL FOR ELECTRICAL WIRE CONNECTION AND ELECTRICAL WIRE CONNECTION STRUCTURE OF SAID TERMINAL

(71) Applicant: SUMITOMO WIRING SYSTEMS, LTD., Mie (JP)

(72) Inventors: Hiroaki TOKUNAGA, Mie (JP); Naofumi YAMATAKE, Mie (JP)

(73) Assignee: SUMITOMO WIRING SYSTEMS, LTD., Mie (JP)

(21) Appl. No.: 15/039,599

(22) PCT Filed: Nov. 27, 2014
(86) PCT No.: PCT/JP14/81323

§ 371 Date: May 26, 2016

(30) Foreign Application Priority Data
Dec. 16, 2013 (JP) 2013-259079

(51) Int. Cl. H01R 4/18; H01R 4/62

(52) U.S. Cl. CPC H01R 4/188; H01R 4/62; H01R 4/184

(57) ABSTRACT

Provided is a terminal to be connected to a partially stripped portion, the partially stripped portion being obtained by stripping an insulating coating at a position located a predetermined distance away from a terminal end of an electrical wire such that a portion in a circumferential direction of the insulating coating remains, partially exposing a core wire, an electrical wire connection portion including one crimped portion in which left and right barrels protrude in both sides of a width direction from a central portion of a base plate, in which rectangular frame-shaped ribs that protrude inwardly along an outer circumferential edge of the crimped portion are provided, a core wire contact portion that protrudes inward as a step is provided in a portion surrounded by the ribs and has a size corresponding to a size of the partially stripped portion of the electrical wire.

### TECHNICAL FIELD

The present invention relates to a terminal for an electrical wire connection and an electrical wire connection structure of the terminal, and in particular is preferably used in the case where an electrical wire to be routed in a vehicle is connected to a terminal in specifications requiring watertightness.

### BACKGROUND ART

Recently, from the viewpoint of reducing the weight, there are cases where instead of a copper electrical wire in which copper-based metal is used as a core wire, an aluminum electrical wire (hereinafter, simply abbreviated to as “aluminum wire”) in which an aluminum-based metal is used as a core wire is used as an electrical wire laid out in a vehicle such as a car. On the other hand, because a terminal to be connected to a terminal end of the aluminum wire is made of copper-based metal similarly to the conventional electrical wire, different metals contact each other in a portion of contact between the terminal and the core wire of the aluminum wire, and thus the electrical connection reliability needs to be increased. Moreover, if water enters the portion of contact between different metals, galvanic corrosion is likely to occur. Therefore, in order to prevent this galvanic corrosion, it is necessary to achieve complete waterproofing to ensure that water does not enter the portion of contact between the electrical wire and the terminal.

In JP 2013-62206A, as shown in FIG. 11, a step portion 118 is used as a connection structure for waterproofing of the portion of contact between the electrical wire and the terminal. The step portion 118 is such that left and right barrels 112 and 114 of a terminal 110 that is connected to the terminal end of an aluminum wire 100 are crimped to a core wire 100a exposed from an insulating coating 100b at the end of the electrical wire 100. The exposed core wire 100a and the vicinity of the stripped end of the insulating coating 100b are surrounded by the barrels 112 and 114, and then a welded portion 150 is formed by welding a portion in which the barrel 112 and the barrel 114 overlap in the longitudinal direction. The welded portion 150 at a front end in the longitudinal direction is bent to a bottom surface 115 of the terminal 110 and welded to the bottom surface.

With this configuration in which the barrels 112 and 114 of the terminal 110 and the bottom surface 115 are welded together and the exposed core wire 100a of the electrical wire 100 is accommodated in a sealed space, in order to achieve waterproofing of the portion in which different metals of the core wire 100a of the aluminum wire 100 and the terminal 110 made of copper-based metal are in contact, corrosion is prevented.

### CITATION LIST

### Patent Documents

Patent Document 1: JP 2013-62206A

### SUMMARY OF INVENTION

### Technical Problem

In the above-described structure for connecting the terminal and the electrical wire in Patent Document 1 shown in FIG. 11, the barrels 112 and 114 are crimped to the outer circumference of the insulating coating that is continuous with the exposure portion of the core wire, a portion in which these barrels 112 and 114 overlap in the longitudinal direction is welded, and thus it can prevent water from intruding from above in FIG. 11. However, a gap C is formed between inner circumferential surfaces 112i and 114i of rear end surfaces of the barrel 112 and 114 in the longitudinal direction and an outer circumferential surface of the insulating coating 100b. If water enters the sealed space surrounded by the welded barrels 112 and 114 through this gap C, moisture adheres to the portion in which different metals of the core wire 100a and the terminal in the sealed space are in contact, resulting in corrosion. Thus, the connection structure of Patent Document 1 does not achieve reliable waterproof conditions and there is a risk of corrosion.

Moreover, in Patent Document 1, the connection structure is complicated because the order of bending the left and right barrels 112 and 114 is specified. Furthermore, it is problematic in that there is a step in the crimped state, and in order to weld the region of this step, it is necessary to perform welding using a laser beam welding machine while controlling the direction of laser light, and thus the welding operation is not simple.

The present invention has been achieved in light of the above-described issues, and provides a terminal for an electrical wire connection and a connection structure of the terminal with which the reliability of an electrical connection with an electrical wire is increased and waterproofing of a portion of electrical contact between the core wire of the electrical wire and the terminal is reliably achieved.

### Solution to Problem

In order to resolve the above-described issues, the present invention provides a terminal for an electrical wire connection, which is to be connected to a partially stripped portion, the partially stripped portion being obtained by stripping an insulating coating at a position located a predetermined distance away from a terminal end of an electrical wire such that a portion in a circumferential direction of the insulating coating remains, partially exposing a core wire,

the terminal including an electrical contact portion for electrical contact with a counterpart terminal on one side in a longitudinal direction of a base plate and an electrical wire connection portion on the other side, the electrical wire connection portion including a crimped portion in which left and right barrels protrude in both sides in a width direction from a central portion of the base plate,

in which a rectangular frame-shaped rib that protrudes inwardly along an outer circumferential edge of the crimped portion is provided, a core wire contact portion that protrudes inward as a step is provided in a portion surrounded by the rib and has a size corresponding to a size of the partially stripped portion of the electrical wire, the core wire contact portion protruding by an amount that corresponds to a thickness of the insulating coating of the electrical wire that is to be connected.

The rectangular frame-shaped rib provided in the crimped portion of the terminal includes: a frontward rib and a rearward rib that protrude inwardly from a tip of one barrel of the left and right barrels to a tip of the other barrel of the left and right barrels through the central portion, over an overall length in a left and right width direction, and a right rib and a left rib that are respectively continuous with the frontward rib and the rearward rib on protruding ends of the left and right barrels and protrude inwardly,

a widthwise length of the core wire contact portion that is surrounded by the rectangular frame-shaped rib including the frontward rib, the rearward rib, the right rib, and the left rib and that protrudes as a step at a predetermined height corresponds to a length in a circumferential direction of the core wire that is exposed at the partially stripped portion of the electrical wire, and its longitudinal length corresponds to the longitudinal length of the exposed core wire, and

protruding lengths of the left and right barrels are set to such length that the insulating coating of the electrical wire is surrounded annularly in a state in which the left and right barrels are crimped to the electrical wire.

Also, the present invention provides an electrical connection structure of a terminal, in which the terminal is made of a copper-based metal plate, and the terminal is connected to an aluminum electrical wire whose core wire is made of aluminum-based metal or a copper electrical wire whose core wire is made of copper-based metal.

Specifically, the terminal is connected to a thick aluminum electrical wire having a core wire cross section of at least 8 mm²,

a length of the partially stripped portion of the electrical wire is 5 to 50 mm, with ¾ of a circumference of the insulating coating being stripped in the circumferential direction and ¼ of the circumference remaining,

the rectangular frame-shaped rib digs into a surface of the insulating coating that surrounds the partially stripped portion by crimping the left and right barrels and the central portion with the partially stripped portion of the electrical wire being surrounded by the crimped portion of the terminal, and the core wire contact portion is brought into contact with and is welded to the exposed core wire at the partially stripped portion by crimping.

If the core wire cross section of the terminal is at least 8 mm² for a thick electrical wire connection, the core wire contact portion of the crimped portion of the terminal is a welding portion that is welded by ultrasonic welding or resistance welding, the core wire contact portion has a shape that corresponds to the shape of the partially stripped portion obtained by exposing the core wire of the electrical wire diametrically opposing each other, and the core wire contact portion is welded to the core wire and the crimped portion is crimped.

In order to perform welding, it is necessary to dispose welding electrodes that diametrically oppose each other. Thus, it is preferable that exposed portions of the core wire of the electrical wire are provided over ranges of 45 degrees that diametrically oppose each other, and since the core wire contact portion of the crimped portion of the terminal preferably covers the core wire continuously, it is preferable that a 90-degree portion, which is ¼ of the circumference, is left standing and ¾ of the circumference is stripped away, as described above.

The terminal that crimps the crimped portion and to which the core wire contact portion is welded is preferably used for a thick electrical wire that is an aluminum electrical wire in which a core wire is made of aluminum-based metal and has a core wire cross section of at least 8 mm², and the aluminum-based core wire and the core wire contact portion are preferably welded by ultrasonic welding.

This is because the melting temperature of aluminum-based core wires is high, and thus ultrasonic welding is preferable to resistance welding.

Thus, the reliability of electrical connection between the thick aluminum electrical wire and the terminal can be increased by crimping the crimped portion of the terminal and welding the core wire contact portion and the core wire.

On the other hand, a terminal in which a serration is provided on the core wire contact portion can be connected to a thin aluminum electrical wire having a core wire cross section of less than 8 mm², and

the rectangular frame-shaped rib digs into a surface of the insulating coating that surrounds the partially stripped portion by crimping the left and right barrels and the central portion with the partially stripped portion of the electrical wire being surrounded by the crimped portion of the terminal, and the serration of the core wire contact portion is brought into contact with the exposed core wire at the partially stripped portion by crimping.

With a thin electrical wire, the necessary electrical connection reliability can be obtained by simply crimping the serration provided on an inner surface of the core wire contact portion of the terminal to the core wire of the thin electrical wire, without welding.

In either case of the thick electrical wire and the thin electrical wire, the rectangular frame-shaped rib that is provided so as to protrude toward the crimped portion of the terminal preferably digs into the insulating coating of the electrical wire in a state in which the insulating coating of the electrical wire is compressed by 15 to 30%.

Thus, since the rectangular frame-shaped rib of the terminal digs into the insulating coating at positions surrounding the core wire contact portion of the terminal that is brought into contact with the core wire of the electrical wire, even if water intrudes along the surface of the electrical wire, the water is blocked by the rib and it is possible to reliably prevent water from entering the contact position at which the exposed core wire and the core wire contact portion of the terminal are in contact with each other.

Also, a length of the base plate on the front side of the crimped portion of the electrical wire connection portion of the terminal corresponds to the length from the tip of the electrical wire to the partially stripped portion, and a front end of the electrical wire does not protrude to the electrical connection portion that is continuous with the front end of the electrical wire connection portion.

It is sufficient that the electrical contact portion of the terminal has a shape such that the electrical contact portion is electrically connectable to a counterpart terminal, and a tab-shaped male terminal, a box-shaped female terminal, or a shape provided with a bolt hole for fastening a bolt may be applicable.

The partially stripped portion to be provided in the vicinity of the tip of the electrical wire can be easily formed by providing front and rear cuts into the insulating coating over a necessary angle range at both ends in the longitudinal direction with a necessary size of the electrical wire remaining, and providing two cuts in the longitudinal direction that connect both ends in the circumferential direction of the front and rear cuts at two locations that are spaced apart at a certain angle, and removing the insulating coating surrounded by the front, rear, left and right cuts.

### Advantageous Effects of Invention

The terminal for an electrical wire connection of the present invention is crimped in a state in which the electrical wire provided with the partially stripped portion is covered by the crimped portion, the core wire contact portion that protrudes inward the crimped portion is brought into contact with the exposed core wire, and a peripheral rectangular frame-shaped rib is in contact with the outer surface of the peripheral insulating coating that surrounds the exposed core wire portion. This crimping causes the rib to dig into the insulating coating that surrounds the exposed core wire portion, and serves as a water-entry barrier for preventing water from entering the portion of contact between the core wire and the terminal. Accordingly, it is possible to reliably achieve the prevention of water entering the portion of contact between the core wire and the terminal, and in particularly the terminal can be preferably used for a connection between an aluminum wire and a copper-based terminal in which corrosion is likely to occur due to entering of water.

Also, in the terminal for a thick electrical wire, which includes an aluminum wire and the like, the core wire contact portion of the crimped portion is welded with the core wire and the crimped portion is crimped, and thus the electrical connection reliability can be increased.

Moreover, in the terminal for a thin electrical wire, which includes an aluminum wire and the like, the electrical connection reliability can be increased by providing a serration on an inner surface of the core wire contact portion of the crimped portion, and strongly crimping the core wire contact portion to the core wire in the crimped state.

### BRIEF DESCRIPTION OF DRAWINGS

FIG. 1 shows a terminal of a first embodiment of the present invention, where FIG. 1(A) is a perspective view, and FIG. 1(B) is a right side view.

FIG. 2(A) is a plan view of an unfolded state before the terminal is folded, FIG. 2(B) is a cross-sectional view taken along B-B line in FIG. 2(A), and FIG. 2(C) is a cross-sectional view taken along C-C line in FIG. 2(A).

FIG. 3 shows an electrical wire that is to be connected to the terminal, where FIG. 3(A) is a perspective view before processing, FIG. 3(B) is a perspective view in a state in which a partially stripped portion is provided, and FIG. 3(C) is a cross-sectional view taken along line C-C in FIG. 3(B).

FIGS. 4(A) to 4(C) are diagrams showing a method for providing the electrical wire with the partially stripped portion.

FIGS. 5(A) and 5(B) are diagrams showing a position at which the electrical wire and the terminal are assembled.

FIG. 6(A) is a perspective view of a state in which a terminal is crimped to the electrical wire, FIG. 6(B) is a cross-sectional view taken along B-B line in FIG. 6(A), and FIG. 6(C) is a cross-sectional view taken along C-C line in FIG. 6(A).

FIG. 7(A) is a cross-sectional view showing a welding step after crimping, and FIG. 7(B) is a cross-sectional view of a welded portion.

FIG. 8 shows a second embodiment, where FIG. 8(A) is a perspective view of a terminal, FIG. 8(B) is a cross-sectional view taken along line B-B in FIG. 8(A), and FIG. 8(C) is a cross-sectional view in a direction orthogonal to FIG. 8(B).

FIG. 9 is a perspective view showing a position at which the electrical wire and a terminal are assembled.

FIG. 10 is a perspective view in a state in which a terminal is crimped to the electrical wire.

FIG. 11 is a diagram showing a conventional example.

### DESCRIPTION OF EMBODIMENTS

Hereinafter, an embodiment of the present invention will be described with reference to the drawings.

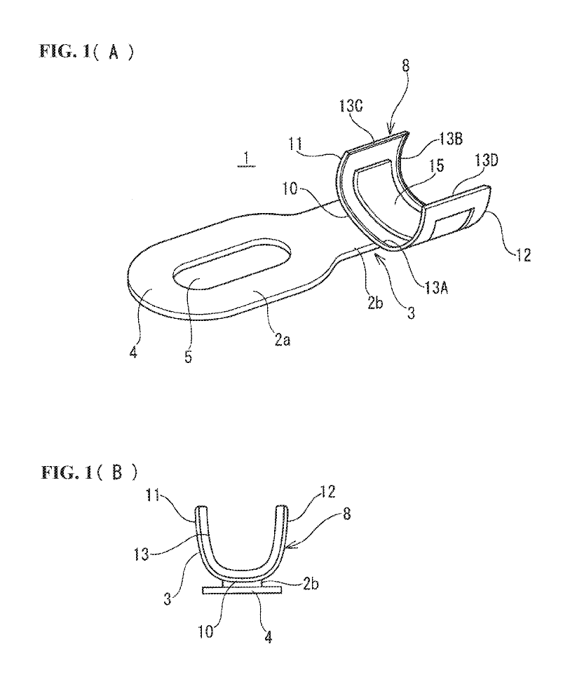

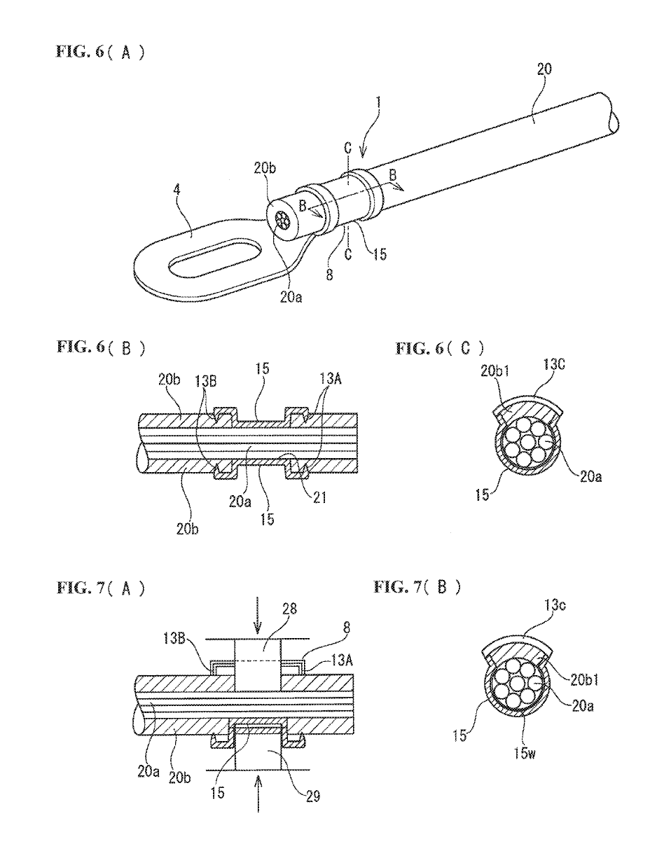

A first embodiment is shown in FIGS. 1 to 7.

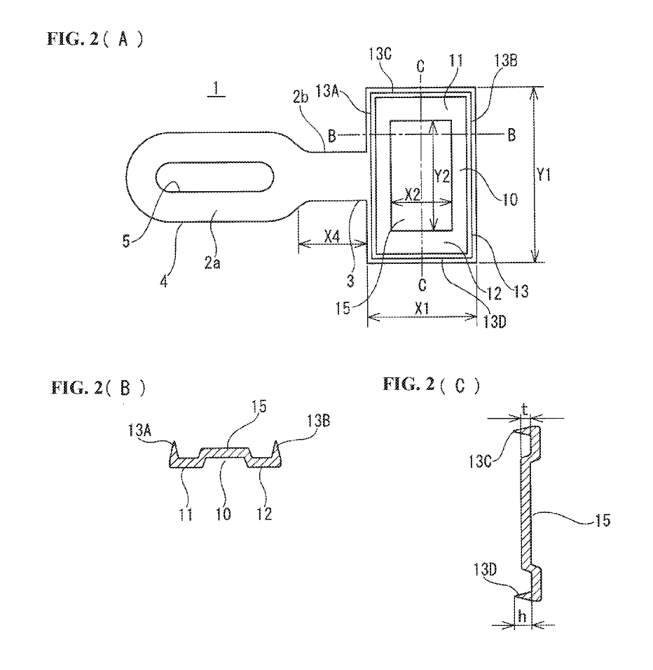

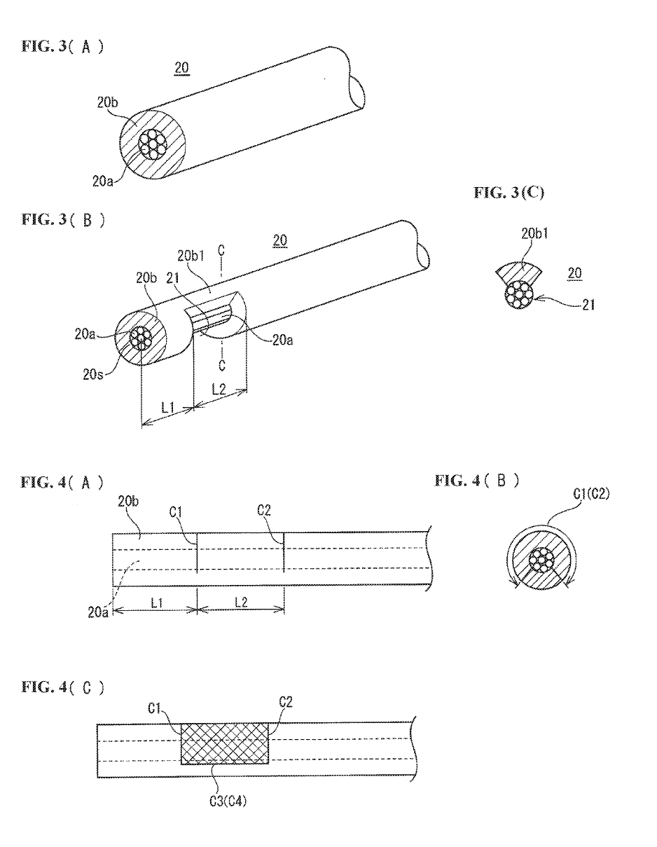

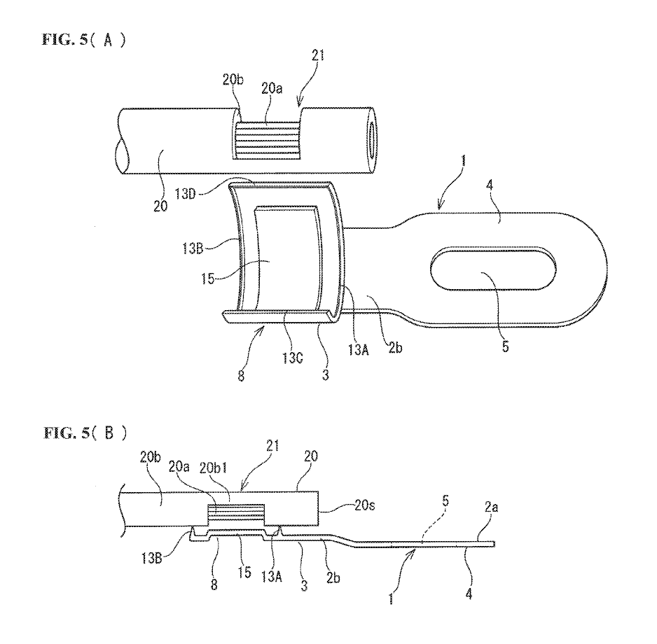

A terminal 1 of the first embodiment shown in FIGS. 1 and 2 is for a connection to an electrical wire 20 including a thick aluminum electrical wire as shown in FIG. 3. The thick aluminum electrical wire is obtained by coating a core wire 20a made of an aluminum-based metal with an insulating coating 20b made of an insulating resin, and is a thick aluminum-based electrical wire (or “thick aluminum wire” in short) in which the cross section of the core wire 2a is at least 8 mm². In order to connect the electrical wire 20 to a counterpart terminal by bolting, the electrical wire 20 is provided with a bolt hole 5 in a base plate 2a of an electrical contact portion 4 of the terminal 1.

As shown in FIGS. 3(B) and 3(C), the electrical wire 20 is provided with a partially stripped portion 21 at a position located a predetermined size L1 away from a terminal end 20s. The partially stripped portion 21 is obtained by letting a portion 20b1 in the circumferential direction of an annular insulating coating 20b stand and stripping at least the insulating coating 20b at a diametrically opposing position, exposing the core wire 20a.

In the present embodiment, a length L2 of the partially stripped portion 21 of the electrical wire 20 is 5 to 50 mm, the portion 20b1 in which the insulating coating 20b remains in the circumferential direction is ¼ of the circumference, and ¾ of the circumference is stripped to expose the core wire 20a.

As shown in FIG. 4, the partially stripped portion 21 of the electrical wire 20 is formed by forming cuts C1 and C2 having a length of ¾ of the circumference, the cuts C1 and C2 being formed in the circumferential direction all the way from the outer circumferential surface down to the inner circumferential surface in the insulating coating 20b at positions located a distance L1 away from the terminal end of the electrical wire 20 and located a distance L2 away therefrom in the longitudinal direction. Moreover, cuts C3 and C4 are formed in the longitudinal direction, connecting both circumferential ends between the cuts C1 and C2 to each other. Thus, stripping is performed by removing a portion of ¾ of the circumference of the insulating coating 20b that is surrounded by four sides, namely, the cuts C1 to C4, as indicated by cross-hatching in FIG. 4.

The terminal 1 is for electrical connection by subjecting the partially stripped portion 21 of the electrical wire 20 to crimping and ultrasonic welding.

The terminal 1 is formed by bending a copper-based metal plate after it is punched. The terminal 1 is provided with an electrical wire connection portion 3 on one side in the longitudinal direction of the base plate 2 and is provided with an electrical contact portion 4 on the other side.

In the electrical wire connection portion 3, the base plate 2b, which is continuous with the base plate 2a of the electrical contact portion 4, extends from the front end to the rear end, and one crimped portion 8 is provided in the rear half of the base plate 2b. The crimped portion 8 includes a central portion 10 extending from the middle to the rear end in the longitudinal direction of the base plate 2b, and left and right barrels 11 and 12 that protrude from left and right sides in the width direction of the central portion 10.

As shown in FIG. 2, in the unfolded state before the left and right barrels 11 and 12 are bent, the crimped portion 8 has a rectangular shape having an overall length Y1 in the left and right width direction, which extends from a protruding end of the barrel 11 through the central portion 10 to a protruding end of the barrel 12, and an overall length X1 in the longitudinal direction. The overall length Y1 in the width direction of the crimped portion 8 is the length corresponding to the outer circumferential length of the insulating coating 20b of the thick aluminum wire 20, and the entire circumference of the insulating coating 20b is covered by the crimped portion 8 in the crimped state.

The length X1 in the longitudinal direction in the crimped portion 8 is the length obtained by extending the length L2 of the partially stripped portion 21 of the electrical wire 20 by a length by which the frontward rib 13a and the rearward rib 13b respectively protrude to the front and rear sides (5 mm in the present embodiment). The X1 is set to 15 to 65 mm.

A rectangular frame-shaped rib 13 protrudes radially inward along the outer circumferential edge of the rectangular crimped portion 8. The rectangular frame-shaped rib 13 includes the frontward rib 13a that extends along a front end side of the barrel 11, the central portion 10, and the barrel 12, the rearward rib 13b that extends along a rear side, the right rib 13c that extends in the longitudinal direction along a protruding end side of the barrel 11, and the left rib 13d that extends in the longitudinal direction along a protruding end of the barrel 12. The rib 13 has a V shape whose tip protrudes in an acute angle, and is configured such that the rib 13 digs into the insulating coating 20b of the electrical wire 20 in the crimped state. A protruding height (t) of the rib 13 is 15 to 20% the thickness of the insulating coating 20b of the thick aluminum wire 20.

A rectangular core wire contact portion 15 that protrudes inward as a step so as to be fit to the partially stripped portion 21 of the electrical wire 20 is provided in an inner portion surrounded by the rectangular frame-shaped rib 13 of the crimped portion 8. The widthwise length Y2 of the core wire contact portion 15 is equal to the circumferential length of the partially stripped portion 21, and the longitudinal length X2 is similar to the longitudinal length of the partially stripped portion 21. Moreover, the protruding amount of the core wire contact portion 15 is equal to a thickness (t) of the insulating coating 20b.

The crimped portion 8 is formed by pressing or stamping the rib 13 and the core wire contact portion 15 to an expanded flat plate shape, and then bending the left and right barrels 11 and 12 to the central portion 10 of the base plate 2b.

Also, the length X4 of the front side portion of the base plate 2a to the front of the crimped portion 8 of the electrical wire connection portion 3 of the terminal 1 corresponds to the length L1 extending from the tip of the electrical wire 20 to the partially stripped portion 21, and the front end 20e of the electrical wire 20 does not protrude to the electrical contact portion 4 that is continuous with the front end of the electrical wire connection portion 3 of the terminal 1.

Next, a method for connecting the terminal 1 and the electrical wire 20 will be described.

First, the partially stripped portion 21 is provided in the electrical wire 20 with the method shown in FIG. 4 above.

Next, as shown in FIGS. 5(A) and 5(B), the terminal 1 is set on the tip side of the electrical wire 20, the tip 20s of the electrical wire 20 is positioned at the front end of the electrical wire connection portion 3 of the terminal 1, and the electrical wire 20 is placed on the base plate 2b. In this state, the partially stripped portion 21 of the electrical wire 20 is located at a position at which the partially stripped portion 21 is covered by the crimped portion 8 of the terminal 1. At this time, in the partially stripped portion 21, the ¼ circumference portion 20b1 in which the insulating coating 20b remains is positioned on the upper side, and an exposed portion of the core wire 20a is positioned on the lower side.

As shown in FIG. 5(B), in the crimped portion 8 of the terminal 1 that covers the partially stripped portion 21 of the electrical wire 20 from below to the both side surfaces of the partially stripped portion 21, the frontward rib 13A and the rearward rib 13B of the rectangular ribs abut against the outer surface of the insulating coating 20b that is adjacent to the front and rear ends in the longitudinal direction of the partially stripped portion 21. Moreover, the left rib 13C and the right rib 13D are positioned adjacent to both side edges in the circumferential direction of the partially stripped portion 21. The core wire contact portion 15 in the center of the crimped portion 8 is fitted into the stripped portion of the partially stripped portion 21, and is positioned in contact with the outer surface of the exposed core wire 20a.

As described above, a welded portion 15W is provided by setting, in the state in which the terminal 1 and the terminal end of the electrical wire 20 are set, as shown in FIG. 7(A), the positions of the core wire contact portion 15 of the crimped portion 8 of the terminal 1 that are diametrically opposite to each other between a pair of welding electrodes 28 and 29 of an ultrasonic welding apparatus, moving the welding electrodes 28 and 29, and welding the core wire contact portion 15 to the exposed core wire 20a of the partially stripped portion 21.

Then, the crimped portion 8 of the terminal 1 is crimped to the electrical wire 20 with a crimping apparatus (not shown).

In this crimping step, crimping is performed such that the rectangular frame-shaped ribs 13A to 13D dig into the outer circumferential surface of the insulating coating 20b that surrounds the partially stripped portion 21 of the electrical wire 20, and the insulating coating 20b is compressed by 15 to 20%. Accordingly, no gap is formed between the crimped portion 8 of the terminal 1 and the insulating coating 20b of the electrical wire 20, an the rib 13 serves as the barrier for water intruding from the gap, which reliably keeps water from intruding.

Thus, the connection between the electrical wire 20 and the terminal 1 is performed by sequentially crimping and welding. In the crimping step, the crimped portion 8 of the terminal 1 is crimped to the partially stripped portion 21 of the electrical wire 20, and the portion of contact between the exposed core wire portion 15 and the core wire 20a is completely surrounded by the rectangular frame-shaped ribs 13A to 13D digging into the insulating coating 20b, and therefore the portion of contact between the core wire contact portion 15 and the core wire 20a is located in a sealed space. As a result of this, it is possible to prevent corrosion resulting from droplets adhering to a portion in which different metals of the core wire 20a and the core wire contact portion 15 are in contact with each other.

Furthermore, since the core wire contact portion 15 is brought into contact with the core wire 20b by crimping, and is welded by ultrasonic welding, the electrical connection reliability increases. Thus, the terminal 1 can be used for the connection to a thick aluminum wire.

Note that the electrical wire that is connected to a core wire of the terminal end of the electrical wire by crimping and welding, using the terminal 1 of the first embodiment, is not limited to a thick aluminum wire, and can also be used for connection to a copper electrical wire in which the core wire is made of copper-based metal.

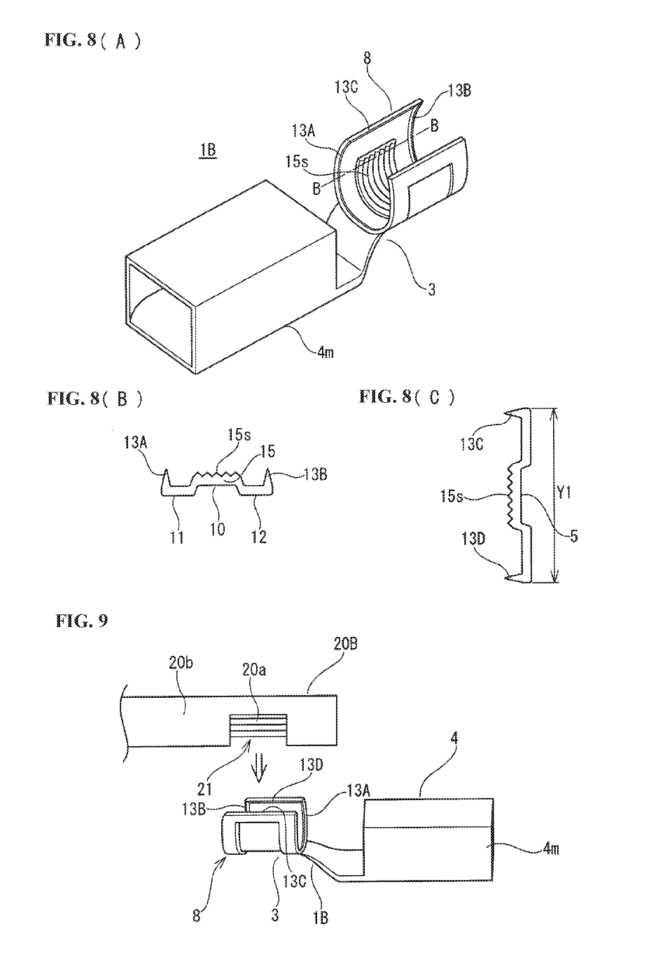

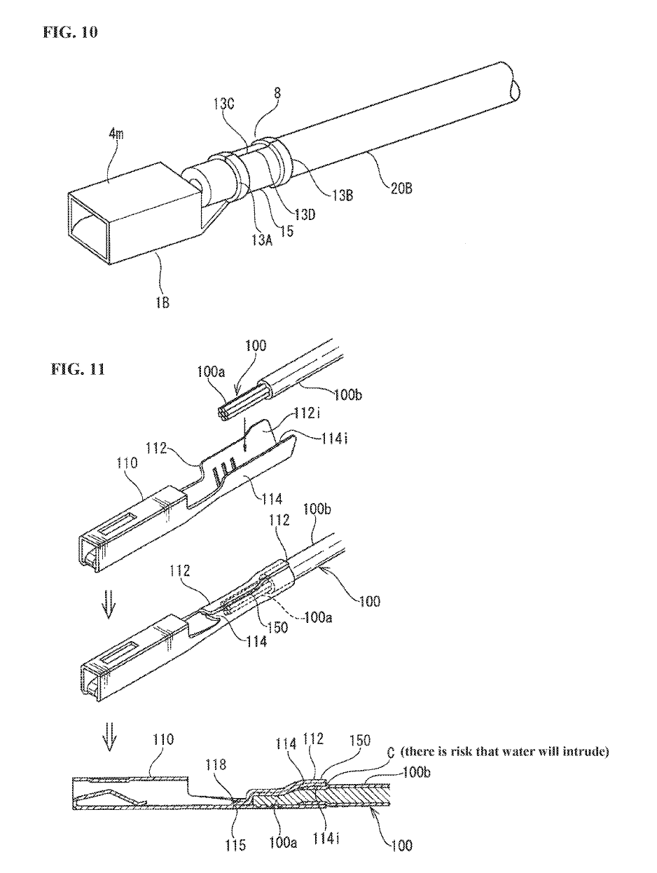

A second embodiment is shown in FIGS. 8 to 10.

In the second embodiment, an electrical wire 20B including aluminum wire (thin aluminum wire) having a core wire cross section of less than 8 mm² is connected to a terminal 1B by crimping, and ultrasonic welding is not performed.

Similarly to the electrical wire 20 of the first embodiment, the electrical wire 20B is provided with a partially stripped portion 21 obtained by stripping an insulating coating 20b over ¾ of its circumference, in the vicinity of the tip. Note that since the partially stripped portion 21 is not subjected to ultrasonic welding, the core wire 20a does not need to be exposed over such a circumferential length that includes positions that diametrically oppose each other, but from the viewpoint of increasing the contact area with the core wire contact portion 15 provided in the terminal 1B, the core wire 20a is preferably exposed by stripping ¾ of the circumference of the insulating coating, similarly to the first embodiment.

The electrical contact portion 4 of the terminal 1B is not for a thick electrical wire that is used to connect an electrical wire to a power source line, and thus is provided with a box-shaped female terminal 4m into which a male terminal (tab) serving as the counterpart terminal can be inserted for a fitting connection.

The electrical wire connection portion of the terminal 1B has a shape similar to that of the electrical wire connection portion of the terminal 1 of the first embodiment, the electrical wire connection portion 3 is provided with one crimped portion 8, rectangular frame-shaped ribs 13A to 13D are provided along the circumferential edge of the crimped portion 8, and a core wire contact portion 15 that protrudes inward as a step is provided on an inner portion surrounded by the ribs 13A to 13D. A serration 15s in which linear protruding portions are provided in parallel is provided on the inner surface of this core wire contact portion 15. Although the terminal 1B has a shape similar to that of the terminal 1 of the first embodiment except that it is provided with the serration 15s, a width Y1 of the crimped portion 8 is made smaller than that of the terminal 1 of the first embodiment because the terminal 1B is for a thin aluminum wire.

With the electrical wire 20B including the thin aluminum wire, a sufficient electrical contact reliability is obtained by only crimping the core wire contact portion 15 of the crimped portion 8 of the terminal 1B, and thus no ultrasound welding is performed. In particular, since the serration 15s is provided on the inner surface of the core wire contact portion 15 that is brought into intimate contact with the outer circumferential surface of the core wire 20a, the protruding portions of the serration 15s are strongly pressed against the core wire 20a, and thus the electrical contact reliability can be increased even more.

Also, similarly to the first embodiment, since the rectangular frame-shaped rib 13 digs into the outer surface of the insulating coating 20b at the outer circumference that surrounds the portion of contact between the electrical contact portion 15 of the terminal 1B and the core wire 20a of the electrical wire and the rectangular frame-shaped rib 13 surrounds the insulating coating 20b, the portion of contact between the electrical contact portion 15 and the core wire 20a forms into a sealed space and thus it is possible to reliably prevent water from entering the contact portion.

The present invention is not limited to the above-described first and second embodiments, and the electrical wire that is to be connected to the terminals 1 and 1B may also be a copper electrical wire. Also, a configuration is possible such that a partially stripped portion provided in the electrical wire is not limited to the shape in which ¾ of the circumference of the insulating coating is stripped and ¼ of the circumference remains, and 90-degree portions that are opposite to each other are stripped and two core wire contact portions that are to be provided in the terminal are provided in parallel and spaced apart form each other. Furthermore, with a terminal for a connection to a thin electrical wire, in order to perform welding, it is not necessary to provide stripped portions at positions that are diametrically opposite to each other for welding, and thus a partially stripped portion obtained by stripping only half the circumference, i.e. 180 degrees, may be used. Moreover, various modifications can be made on the present invention without departing from the gist of the present invention.

### REFERENCE SIGNS LIST

1 Terminal
2 Base plate
3 Electrical wire connection portion
4 Electrical contact portion
8 Crimped portion
13 (13A to 13D) Rib
15 Core wire contact portion
20 Electrical wire
20a Core wire
20b Insulating coating
21 Partially stripped portion

1. A terminal for an electrical wire connection, configured to be connected to a partially stripped portion having an insulating coating stripped at a position located a predetermined distance away from a terminal end of an electrical wire such that a portion in a circumferential direction of the insulating coating remains, partially exposing a core wire,
the terminal being made of a conductive metal plate, and comprising an electrical contact portion configured for electrical contact with a counterpart terminal on one side in a longitudinal direction of a base plate and an electrical wire connection portion on the other side, the electrical wire connection portion including one crimped portion in which left and right barrels protrude on both sides in a width direction from a central portion of the base plate,
wherein a rectangular frame-shaped rib protrudes inwardly along an outer circumferential edge of the crimped portion, a core wire contact portion protrudes inward as a step in a portion surrounded by the rib and has a size corresponding to a size of the partially stripped portion of the electrical wire, the core wire contact portion protruding by an amount that corresponds to a thickness of the insulating coating of the electrical wire that is to be connected.

2. The terminal for an electrical wire connection according to claim 1, wherein
the rectangular frame-shaped rib includes: a frontward rib and a rearward rib that protrude inwardly from a tip of one barrel of the left and right barrels to a tip of the other barrel of the left and right barrels through the central portion, over an overall length in a left and right width direction, and a right rib and a left rib that are respectively continuous with the frontward rib and the rearward rib on protruding ends of the left and right barrels and protrude inwardly,
a widthwise length of the core wire contact portion that is surrounded by the rectangular frame-shaped rib including the frontward rib, the rearward rib, the right rib, and the left rib and that protrudes as a step at a predetermined height corresponds to a length in a circumferential direction of the core wire that is exposed at the partially stripped portion of the electrical wire, and its longitudinal length corresponds to the longitudinal length of the exposed core wire, and
protruding lengths of the left and right barrels are such that the insulating coating of the electrical wire is surrounded annularly in a condition in which the left and right barrels are crimped to the electrical wire.

3. The terminal for an electrical wire connection according to claim 1, wherein a serration is provided on an inner surface of the core wire contact portion of the crimped portion.

4. An electrical wire connection structure of a terminal, wherein the terminal according to claim 1 is made of a copper-based metal plate, and the terminal is connected to an aluminum electrical wire whose core wire is made of aluminum-based metal or a copper electrical wire whose core wire is made of copper-based metal.

5. The electrical wire connection structure of a terminal according to claim 4, wherein
the terminal is connected to a thick aluminum electrical wire having a core wire cross section of at least 8 mm²,
a length of the partially stripped portion of the electrical wire is 5 to 50 mm, with ¾ of a circumference of the insulating coating being stripped in the circumferential direction and ¼ of the circumference remaining,
the rectangular frame-shaped rib digs into a surface of the insulating coating that surrounds the partially stripped portion by crimping the left and right barrels and the central portion with the partially stripped portion of the electrical wire being surrounded by the crimped portion of the terminal, and the core wire contact portion is welded to and is brought into contact with the exposed core wire at the partially stripped portion by crimping.

6. The electrical wire connection structure of a terminal according to claim 4, wherein
the terminal has a serration on an inner surface of the core wire contact portion of the crimped portion, and is connected to a thin aluminum electrical wire having a core wire cross section of less than 8 mm², and
the rectangular frame-shaped rib digs into a surface of the insulating coating that surrounds the partially stripped portion by crimping the left and right barrels and the central portion with the partially stripped portion of the electrical wire being surrounded by the crimped portion of the terminal, and the serration of the core wire contact portion is brought into contact with the exposed core wire at the partially stripped portion by crimping.
